(19) United States
(12) Patent Application Publication
(10) Pub. No.: US 2013/0066716 A1
(43) Pub. Date: Mar. 14, 2013

(54) SENTIMENT-TARGETING FOR ONLINE ADVERTISEMENT

(71) Applicants: Luoqi Chen, Saratoga, CA (US); Jun Ye, Palo Alto, CA (US); Ya Luo, Milpitas, CA (US); Yu Cao, Saratoga, CA (US); Wei Zhuang, Palo Alto, CA (US); Hanying Feng, Fremont, CA (US)

(72) Inventors: Luoqi Chen, Saratoga, CA (US); Jun Ye, Palo Alto, CA (US); Ya Luo, Milpitas, CA (US); Yu Cao, Saratoga, CA (US); Wei Zhuang, Palo Alto, CA (US); Hanying Feng, Fremont, CA (US)

(73) Assignee: Founton Technologies, LTD., Mountain View, CA (US)

(21) Appl. No.: 13/230,720

(22) Filed: Sep. 12, 2011

(51) Int. Cl. G06Q 30/00

(52) U.S. Cl. 705/14.49

(57) ABSTRACT

The various embodiments described in the present disclosure, in at least one aspect, relate to computer-implemented methods of online advertisement. In one embodiment, a method includes, in response to receiving a request for an ad to be provided to a user in an online session, identifying a plurality of ads as candidates for consideration, determining one or more sentiments of a content of the online session, and ranking the plurality of identified ads based at least in part on (i) a correlation between the content of the online session and a content of each identified ad, and (ii) a correlation between the one or more sentiments of the content of the online session and the content of each identified ad.

### TECHNICAL FIELD

The present disclosure, in at least one aspect, relates to systems and methods of providing advertising in a network environment, and more particularly to systems and methods of providing online advertising using various sentiment-targeting approaches.

### BACKGROUND

The increasing popularity of computers and use of communication networks such as the Internet has revolutionized the manner in which advertisers and vendors advertise products and services. Communication networks such as the Internet provide the opportunity for advertisers to reach a wide audience of potential customers. For example, search engines such as Baidu.com, web portal services such as Sina.com, and affiliate programs provide advertisers the opportunity to place ads on their webpages. The ads may comprise hyperlinks (e.g., URLs) to vendors' websites. The effectiveness of an ad campaign may be measured by click-through rate, i.e., the rate online users click on the ad and complete an action. To achieve a click-through, an ad may advantageously be chosen such that the content of the ad is relevant to the user's interest. For example, when a user is reading a webpage about a certain vacation destination, an ad about travel packages to that vacation destination might be of interest to the user and thus is more likely to be clicked by the user. This is often referred to as interest-targeting advertisement. However, by simply selecting an ad that matches a topic of a webpage, the selected ad may not always be appropriate or advantageous to be displayed with the webpage. For example, if the webpage is about food poisoning, it may not be advantageous to display an ad about a restaurant.

Therefore, a heretofore unaddressed need exists in the art to address at least the aforementioned deficiencies and inadequacies.

### BRIEF SUMMARY

The various embodiments described in the present disclosure, in at least one aspect, relate to computer-implemented methods of online advertisement. In one embodiment, a method includes, in response to receiving a request for an ad to be provided to a user in an online session, identifying a plurality of ads as candidates for consideration, determining one or more sentiments of a content of the online session, and ranking the plurality of identified ads based at least in part on (i) a correlation between the content of the online session and a content of each identified ad, and (ii) a correlation between the one or more sentiments of the content of the online session and the content of each identified ad. The method further includes selecting an ad among the plurality of identified ads based at least in part on a result of the ranking, and providing the selected ad to be displayed to the user in the online session.

According to various embodiments, ranking the plurality of identified ads includes determining a sentiment score for each identified ad and ranking the plurality of identified ads according to the sentiment scores. In one embodiment, determining one or more sentiments of the online session includes determining a sentiment vector for the content of the online session. The sentiment vector has one or more components corresponding to the one or more sentiments. In one embodiment, each component of the sentiment vector may be in one of three states: positive, neutral, or negative. In another embodiment, each component of the sentiment vector is assigned a number in a numerical range. The two extrema of the numerical range indicates most negative and most positive sentiments, respectively. In one embodiment, determining a sentiment score for each respective identified ad is performed using a lookup table that operates on the sentiment vector. The lookup table indicates a relative degree of appropriateness of the respective identified ad with respect to the sentiment vector.

In a further embodiment, ranking the plurality of identified ads is further based at least in part on a correlation between the one or more sentiments of the content of the online session and an ad creative of each respective identified ad.

These and other aspects of the present disclosure will become apparent from the following description of various embodiments taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments and together with the written description, serve to explain various principles of the invention. Wherever possible, the same reference numbers are used throughout the drawings to refer to the same or like elements of an embodiment, and wherein:

FIG. 1 shows an example of a webpage including an ad displayed next to a news article;

FIG. 2 illustrates a method of selecting an ad to be displayed with a webpage content according to one embodiment;

FIG. 3 illustrates a method of selecting an ad to be displayed with a webpage content according to one embodiment, the ad including an ad creative;

FIG. 4 shows a schematic diagram of a network environment that may incorporate various embodiments; and

FIG. 5 shows a flowchart illustrating a method of online advertisement according to one embodiment.

### DETAILED DESCRIPTION

Various embodiments will now be described more fully hereinafter with reference to the accompanying drawings, in which exemplary embodiments are shown. Various aspects may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

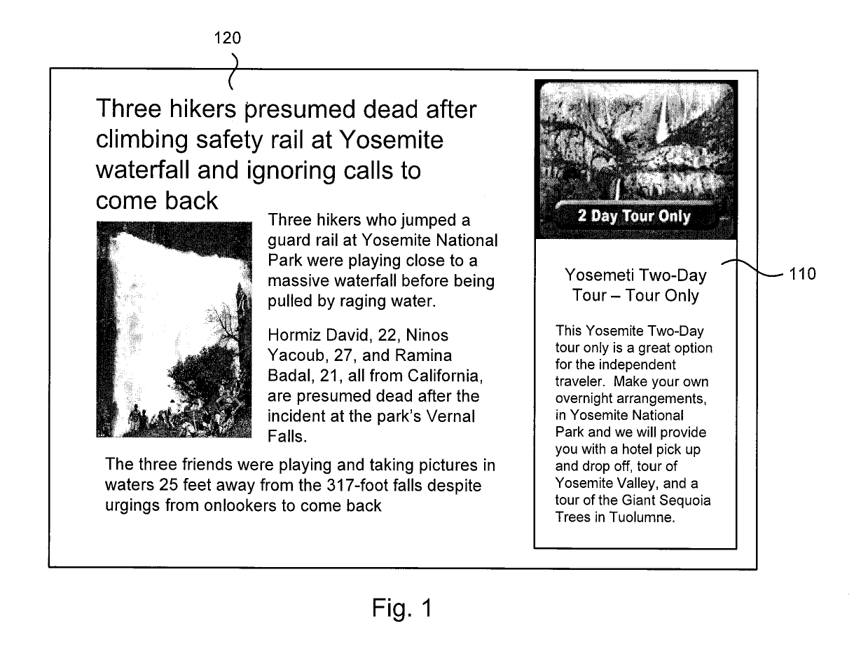

One of the most commonly used methods of context-targeting advertisement is to match an ad with a topic of the online session in which the ad is served, usually through keyword(s) matching. For example, if an article in a webpage contains keywords such as “milk-powder,” “baby food,” or “baby,” an ad about baby formula may be selected to be displayed with the article in the webpage. However, an ad selected based purely on keywords matching may or may not be appropriate or advantageous for display with the article depending on the sentiment of the article. For example, if the article talks about the health benefits of baby formula for babies, in other words, the article has a positive sentiment toward baby formula, then an ad about baby formula would be advantageously displayed with the article. On the other hand, if the article talks about why baby formula is inferior to breast feeding, in other words, the article has a negative sentiment toward baby formula, then an ad about baby formula would not be appropriate to be displayed with the article. FIG. 1 illustrates another example where an inappropriate ad is chosen for a webpage content. In this case, an ad 110 about tour packages to Yosemite National Park is displayed next to a news article 120 about a tragic accident recently happened in Yosemite National Park. Although the content of the ad 110 matches the topic of the news article 120, the ad 110 is not appropriate for the content because the news article 120 has a negative sentiment, particularly toward Yosemite National Park.

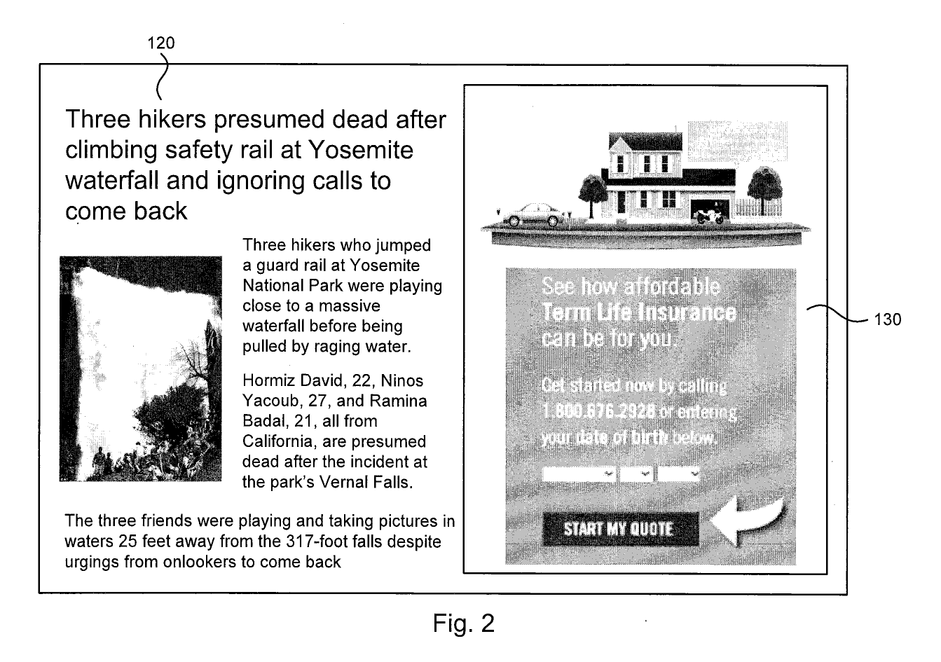

Ads may be pre-associated with certain sentiments according to their contents. For example, ads related to food, travel, entertainment, home decoration, cars for sale, and houses for sale, are generally more appropriate for display with contents that have positive or neutral sentiments. Some ads, such as ads related to life insurance or home insurance, may be indifferent to sentiment, i.e., they are suitable for display with contents that have either positive or negative sentiments. On the other hand, some ads, such as ads related to hospitals, prescription drugs, medical treatments, and injury law firms, may be more appropriate for display with contents that have negative sentiments. In general, branding ads, especially ads related to pleasurable things would be more appropriate for display with contents that have positive sentiments. Ads related to fixing things or solving problems would be either indifferent to sentiment or more appropriate for display with contents that have negative sentiments. FIG. 2 illustrates an example where an ad 130 about term life insurance may be advantageously displayed next to the news article 120 about the tragic accident happened in Yosemite National Park shown in FIG. 1.

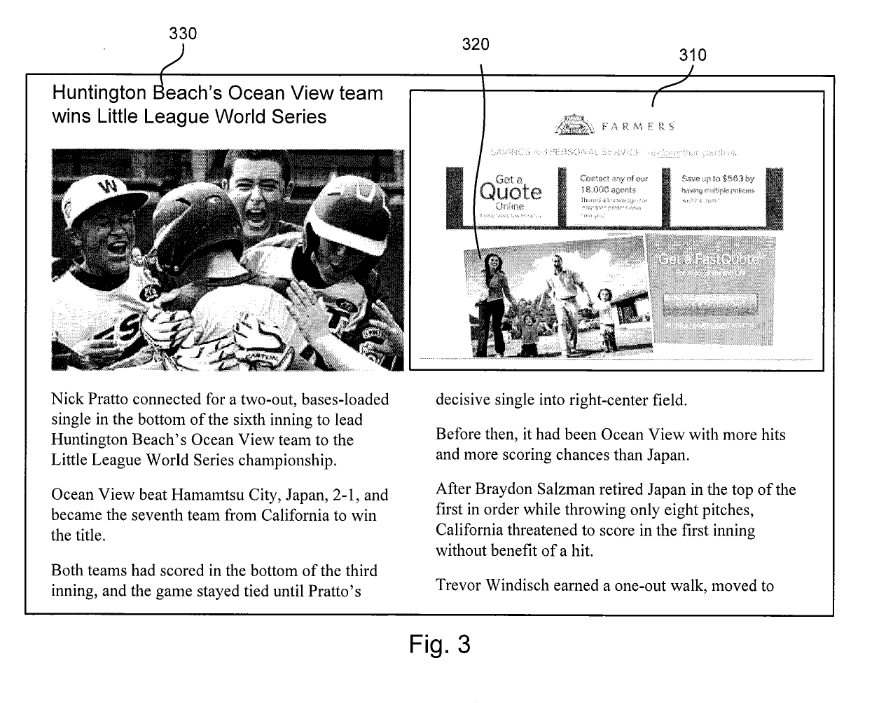

As another aspect, an ad creative may also be advantageously chosen to be used in an ad according to a sentiment of a content. For example, as illustrated in FIG. 3, an insurance ad 310 advantageously uses a cheerful ad creative, such as a picture of a happy family 320, for display with a news article 330 that has a positive sentiment. On the other hand, as illustrated in FIG. 2, a term life insurance ad may advantageously use a relatively low-key ad creative, such as a picture of a house, for display with a content with a negative sentiment.

The present disclosure, in one aspect, relates to systems and methods of providing online advertisement using various sentiment-targeting algorithms. In one embodiment, an exemplary method involves, in response to receiving a request for an ad to be provided to a user in an online session, identifying a plurality of ads as candidates for consideration, determining one or more sentiments of a content of the online session, and determining a sentiment-targeting score for each respective identified ad based at least in part on (i) a correlation between the content of the online session and a content of the respective identified ad, and (ii) a correlation between the one or more sentiments of the content of the online session and the content of the respective identified ad. The method further includes selecting an ad among the plurality of identified ads based at least in part on the sentiment-targeting scores, and providing the selected ad to be displayed to the user in the online session. In a further embodiment, determining a sentiment-targeting score for each respective identified ad is further based at least in part on a correlation between the one or more sentiments of the content of the online session and an ad creative of the respective identified ad.

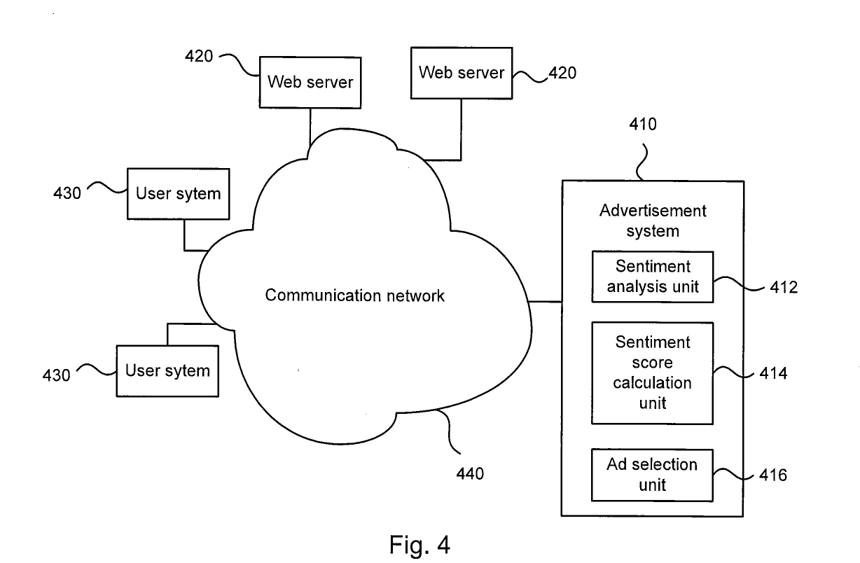

FIG. 4 shows a schematic diagram of an example network environment that may incorporate an embodiment of the present invention. The advertisement system 410 is interconnected with one or more web servers 420 and one or more user systems 430 via a communication network 440. The advertisement system 410 comprises a sentiment analysis unit 412, a sentiment score calculation unit 414, and an ad selection unit 416. In one embodiment, the advertisement system 410 identifies a plurality of ads in response to receiving a request for an ad to be provided to a user in an online session. The sentiment analysis unit 412 analyzes one or more sentiments of a content of the online session. The sentiment score calculation unit 414 calculates a sentiment-targeting score for each of the plurality of identified ads based at least in part on a correlation between the content of the online session and a content of each identified ad and a correlation between the one or more sentiments of the content of the online session and the content of each identified ad. The ad selection unit 416 selects an ad among the plurality of identified ads based at least in part on the sentiment-targeting scores. The advertisement system 410 then provides the selected ad to be displayed with the online session. It is understood that the sentiment analysis unit 412, the sentiment score calculation unit 414, and the ad selection unit 416 may be in separate modules or be in an integrated module.

Communication network 440 provides a mechanism for allowing communication between the various systems depicted in FIG. 4. Communication network 440 may be a local area network (LAN), a wide area network (WAN), a wireless network, an Intranet, the Internet, a private network, a public network, a switched network, or any other suitable communication network. Communication network 440 may comprise many interconnected computer systems and communication links. The communication links may be hardwire links, optical links, satellite or other wireless communications links, wave propagation links, or any other mechanisms for communication of information. Various communication protocols may be used to facilitate communication of information via the communication links, including TCP/IP, HTTP protocols, extensible markup language (XML), wireless application protocol (WAP), protocols under development by industry standard organizations, vendor-specific protocols, customized protocols, and others.

User systems 430 can be of various types including a personal computer, a portable computer, a workstation, a network computer, a mainframe, a smart phone, a personal digital assistant (PDA), a kiosk, or any other data processing system.

The advertisement system 410 may be embodied in the form of a computer system. Typical examples of a computer system include a general-purpose computer, a programmed microprocessor, a micro-controller, a peripheral integrated circuit element, and other devices or arrangements of devices that are capable of implementing the steps constituting the method of the present invention. The computer comprises a microprocessor, a communication bus, and a memory. The memory may include Random Access Memory (RAM) and Read Only Memory (ROM). Further, the computer system comprises a storage device, which can be a hard disk drive or a removable storage drive such as a floppy disk drive, an optical disk drive, and the like. The storage device can also be other similar means for loading computer programs or other instructions into the computer system.

The computer system executes a set of instructions that are stored in one or more storage elements, to process input data. The storage elements may also hold data or other information, as desired. The storage elements may be an information source or physical memory element present in the processing machine. The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module within a larger program, or a portion of a program module. The software might also include modular programming in the form of object-oriented programming. Processing of input data by the processing machine may be in response to user commands, to the results of previous processing, or to a request made by another processing machine.

Aspects of the present invention can be stored as program code in hardware and/or software. Storage media and non-transitory computer readable media for containing code, or portions of code, for implementing aspects and embodiments of the present invention can include, for example and without limitation, magnetic disk drive, magnetic tapes, floppy disks, optical disks, CD-ROMs, digital versatile disk (DVD), magnetic-optical disks, read-only memories (ROMs), random access memories (RAMs), erasable programmable ROMs (EPROMs), and electrically erasable programmable ROMs (EEPROMs).

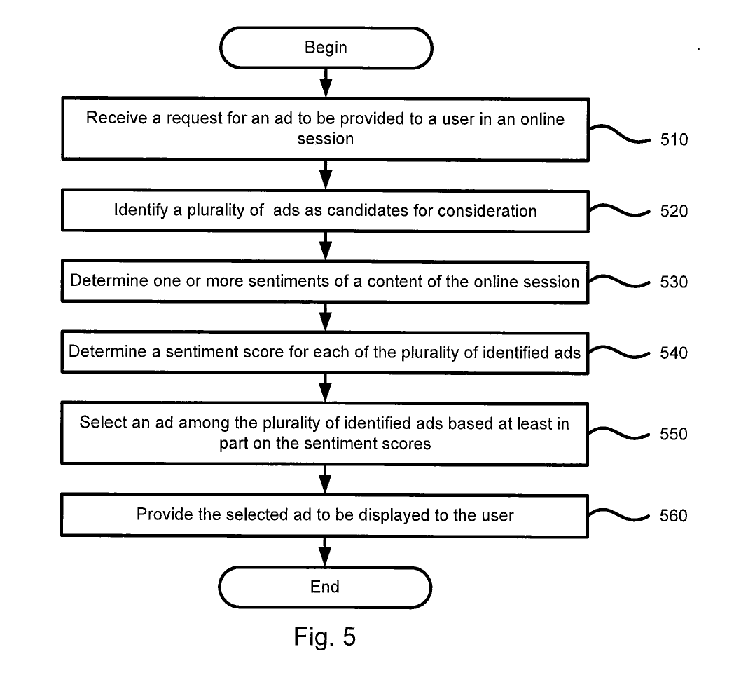

FIG. 5 shows a flowchart illustrating a method of online advertisement according to one embodiment. At step 510, an advertisement system (or service) receives a request for an ad to be provided to a user in an online session. At step 520, the system identifies a plurality of ads as candidates for consideration, as may be generated using any appropriate technique known or used in the art for such purposes. At step 530, the system determines one or more sentiments of a content of the online session. At step 540, the system determines a sentiment score for each of the plurality identified ads. At step 550, the system selects an ad among the plurality of identified ads based at least in part on the sentiment scores, such as by selecting the ad with the highest sentiment score or lowest sentiment score, or the sentiment score closest to a pre-determined value. At step 560, the system provides the selected ad to be displayed to the user in the online session.

In the following various sentiment-targeting algorithms are described according to various embodiments.

### Sentiment Vector

According to various embodiments, in response to receiving a request for an ad to be provided to a user in an online session, the advertisement system analyzes one or more sentiments of a content of the online session. The content of the online session may be, for example and without limitation, a news article, a piece of music, or a video clip. If the webpage is a portal page that includes multiple sections, the relevant content is the content of the section within proximity to the ad space. For example, a webpage of Sina.com may include several sections on various topics, such as sports, entertainment, and so on. If the ad space is in proximity to the sports section, the relevant content of the online session is the content in the sports section.

One or more sentiments of a content may be analyzed using sentiment analysis techniques known in the art. For example, techniques using natural language processing, computational linguistics, and text analytics may be applied to identify and extract sentiment information from a content. In the case of a music content, the sentiment may be extracted by analyzing the melody, the title, or the lyrics of the music. In the case of a video content, the sentiment may be extracted by analyzing the spoken words or the music accompanying the video. Sentiment analysis aims to determine the attitude of a speaker or writer with respect to a topic or the overall contextual polarity of a content. At a basic level, the general polarity of a content may be classified into three discrete states: positive, negative, or neutral. At more advanced levels, other sentiments of a content, such as emotional sentiments and attitudes of the writer may also be determined. Such sentiments may include, for example, happy-or-sad, approval-or-disapproval, calm-or-agitated, passionate-or-indifferent, love-or-hate, lavish-or-frugal, and so on. At a more sophisticated level, sentiment analysis aims to evaluate an author's sentiments or attitudes toward specific topics or attributes.

According to some embodiments, a K-dimensional sentiment vector SV is determined for a content, where K is a positive integer. Each component of the SV vector corresponds to one of one or more sentiments. Example sentiments may include happy-or-sad, approval-or-disapproval, and so on, as discussed above. In one embodiment, each component of the SV vector may be in one of three discrete states: positive, neutral, or negative. In an alternative embodiment, each component of the SV vector is assigned a number in a numerical range, say from −5 to +5, where −5 represents most negative, and +5 represents most positive. For example, for the happy-or-sad sentiment, a number −5 may represent “extremely sad,” and a number +5 may represent “extremely happy.” Intermediate numbers will represent various degrees of sadness or happiness. For example, a number +1 may represent “slightly happy,” a number +2 may represent “somewhat happy,” and so on. A number 0 would mean that the content is neutral to this sentiment.

In one embodiment, the sentiment vector SV for an online session may be determined in real time. That is, each time a user loads up a webpage, which may include an article, a piece of music, or a video clip, the sentiment of the webpage is analyzed before an ad is served with the webpage. This may induce too much latency delay in serving the ad and therefore may degrade user experience. In another embodiment, the sentiment analysis is performed in quasi-real time. That is, when a first user loads up a webpage, the sentiment of the webpage is analyzed and a sentiment vector SV is determined for the webpage. When other users load up the same webpage at later times, the same SV vector will be used. In yet another embodiment, webpages that the system may serve ads with are proactively crawled, and SV vectors for these webpages are determined and saved in the system ahead of time.

### Sentiment-Targeting Lookup Table

Sentiment-targeting operates on the K-dimensional SV vector. Each ad may be designed to target a particular combination of sentiments. Since each component of the SV vector has discrete states, a relative degree of appropriateness of an ad with respect to a SV vector may be expressed as a discrete state-to-value lookup table. For each ad, its sentiment-targeting lookup table ST_LKP comprises a K-dimensional vector, of which each component is a lookup table operating on a respective component of the SV vector, i.e.,

ST_LKP(SV)={ST_LKPᵢ(SVᵢ)}, i=1, 2, . . . K.

The possible lookup value of each component of the ST_LKP vector is a value between zero and one, which indicates the ad's relative degree of appropriateness with respect to certain state of a respective sentiment component. For example, if the lookup table ST_LKP has a value of 1 corresponding to the “happy” state of the “happy-or-sad” component, it would mean that the ad is highly appropriate for a “happy” content. Similarly, if the lookup table ST_LKP has a value of 0 corresponding to the “happy” state of the “happy-or-sad” component, it would mean that the ad is indifferent to the fact that the content has a “happy” sentiment. For proper normalization, the sum of the maximum values of individual components in the ST_LKP may be normalized to one, i.e.,

$${\sum }_{i = 1}^{K} MAX ( {ST\_LKP}_{i} ( {SV}_{i} ) ) = 1 ,$$

unless the ad is not targeted toward any sentiment parameters, in which case all components of the ST_LKP vector for all states are set to zero, or equivalently, the entire sentiment targeting step is skipped. Sentiment-targeting lookup tables ST_LKP may be initially determined by advertisers, ad designers, and/or ad experts. After that, they may be continuously tuned based on real data of the ad's effectiveness for different sentiments.

The following provides an illustrative example of how the sentiment targeting lookup table ST_LKP operates according to one embodiment. Assume that the “happy-or-sad” component of the SV vector has three discrete states, namely “happy,” “neutral,” and “sad”. If an ad is targeted particularly for a “happy” content, but is acceptable for “neutral” or “sad” content, the lookup values corresponding to the state of “neutral” and the state of “sad” would be set to zero, while the lookup value corresponding to the state of “happy” would be set to a value between zero and one. If the ad is indifferent to the “happy-or-sad” component, the lookup values corresponding to all three states, namely “happy,” “neutral,” and “sad,” would all be set to zero. In general, if an ad is indifferent to a sentiment component, the lookup values for all states of that sentiment component should be set to zero. On the other hand, if the ad is NOT appropriate for a particular state, say the “sad” state, the lookup value corresponding to the state of “sad” may be assigned a large negative value.

In alternative embodiments, different sentiment-targeting lookup tables may be used for an ad depending on a correlation between the content of the ad and the content of the online session. In one embodiment, a first lookup table ST_LKP_1 is used when the content of the ad matches with a topic of the online session, and a second lookup table ST_LKP_2 is used when the content of the ad is irrelevant to the topic of the online session. For example, for an ad on cars, a first lookup table ST_LKP_1 is used when the topic of the online session is related to transportation, and a second lookup table ST_LKP_2 is used when the topic of the online session is irrelevant to transportation. In general, sentiment-targeting may be more important when the content of the ad is related to the topic of the online session than when the content of the ad is irrelevant to the topic of the online session. In the above example, ST-LKP_1 may reflect a strong positive or negative correlation between the ad and a particular sentiment, while ST_LKP_2 may reflect an indifference to that particular sentiment. According to one embodiment, the system first determines a correlation between the content of the ad and the content of the online session. The system then determines which lookup table, ST_LKP_1 or ST_LKP_2, to use according to the determined correlation.

In yet another embodiment, each ad may have a plurality of special lookup tables corresponding to a plurality of predetermined topics, and a default lookup table for all other topics. This may be useful when an ad has specific sentiment-targeting requirement for content with one or more particular topics. For example, for an ad on baby formula, a first lookup table ST_LKP_1 may be used for content about baby food, a second lookup table ST_LKP_2 may be used for content about babies and mothers, and a default lookup table ST_LKP_Default is used for content on any other topics. In this case, the system first determines if the topic of the online session matches any of the predetermined topics associated with the plurality of special lookup tables. If the topic of the online session matches with one of the predetermined topics, the system uses the corresponding special lookup table. On the other hand, if the topic of the online session does not match any of the predetermined topics, the system uses the default lookup table.

### Sentiment Score

In one embodiment, after the system has identified a plurality of ads and has determined the sentiment vector SV for the online session, the system determines a sentiment-targeting score for each identified ad according to the following equation,

$$ST = {\sum }_{i = 1}^{K} {ST\_LKP}_{i} ( {SV}_{i} ) .$$

The maximum possible value of the sentiment-targeting score ST is 1.0, but may be a large negative value if a prohibited sentiment component is excited by a content.

In one embodiment, the sentiment score ST is used as a part of an overall ad-targeting score for the ad,

AdScore=c_{ST}·ST+cₒₜₕₑᵣ·Sₒₜₕₑᵣ,

where AdScore is the overall ad-targeting score, ST is the sentiment-targeting score, Sₒₜₕₑᵣ is a targeting score from all non-sentiment-related targeting such as interest-targeting, demographic-targeting, etc., and c_{ST} and cₒₜₕₑᵣ are coefficients that represent the relative weights given to sentiment and non-sentiment targeting, respectively.

### Ad Selection

In one embodiment, after the system has determined the ad-targeting scores for a plurality of ads, the system selects an ad among the plurality of ads to be used in an ad impression based on the determined ad-targeting scores. In one embodiment, the system selects an ad that has the highest ad-targeting score among the plurality of ads. In other embodiments, the system selects an ad based on a probability function that is proportional to the ad-targeting scores, or proportional to the n^{th} power of the ad-targeting scores. In this case, any ads that have negative ad-targeting scores should be first disqualified from consideration.

### Ad Creative Sentiment-Targeting

As discussed above, an ad creative may also be advantageously chosen to be used in an ad according to a sentiment of a context. For example, a life insurance ad may advantageously use a cheerful ad creative, such as a picture of a happy family, for display with a content that has a “happy” sentiment. On the other hand, a life insurance ad may advantageously use a relatively low-key ad creative, such as a picture of a house, for display with a content that has a “sad” sentiment. According to some embodiments, a method also uses sentiment-targeting for selecting an ad creative to be used with an ad content. For each ad, there are a plurality of ad creatives that can be used with the ad. Each of the plurality ad creatives has an associated lookup table operating on the SV vector.

In one embodiment, the system first selects an ad content according to the sentiment-targeting algorithm described above. The system then calculates an ad-creative sentiment-targeting score ST_{Creative} for each of a plurality of ad creatives corresponding to the selected ad content. An ad creative among the plurality of ad creatives is then selected to be used with the selected ad content according to the ad-creative sentiment-targeting scores.

In another embodiment, for each ad under consideration, the system determines a content sentiment-targeting score ST_{Content} and an ad-creative sentiment-targeting score ST_{Creative}. A composite sentiment-targeting score ST is then determined as a weighted combination of the two sentiment-targeting scores,

ST=d·ST_{Content}+(1−d)·ST_{Creative},

where d and (1−d) represent the relative weights given to content sentiment-targeting and creative sentiment-targeting, respectively. The composite sentiment-targeting score ST is then used in selecting a combination of an ad content and an ad creative.

The foregoing description of the exemplary embodiments has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A computer-implemented method of providing a targeted online advertisement, the method comprising:
receiving a request for an ad to be provided to a user in an online session;
identifying, using a processor of a computer, a plurality of ads as candidates for consideration;
determining, using a processor of a computer, one or more sentiments of a content of the online session;
ranking, using a processor of a computer, the plurality of identified ads based at least in part on (i) a correlation between the content of the online session and a content of each respective identified ad, and (ii) a correlation between the one or more sentiments of the content of the online session and the content of each respective identified ad;
selecting, using a processor of a computer, an ad among the plurality of identified ads based at least in part on a result of the ranking; and
providing the selected ad to be displayed to the user in response to receiving the request.

2. The computer-implemented method of claim 1, wherein ranking the plurality of identified ads comprises:
determining, using a processor of a computer, a sentiment-targeting score for each respective identified ad based at least in part on (i) a correlation between the content of the online session and a content of each respective identified ad, and (ii) a correlation between the one or more sentiments of the content of the online session and the content of each respective identified ad; and
ranking the plurality of identified ads according to the sentiment-targeting scores.

3. The computer-implemented method of claim 2, wherein determining one or more sentiments of a content of the online session comprises determining a sentiment vector for the content of the online session, the sentiment vector having one or more components corresponding to the one or more sentiments.

4. The computer-implemented method of claim 3, wherein each component of the sentiment vector is in one of three states: (i) positive, (ii) neutral, or (iii) negative.

5. The computer-implemented method of claim 3, wherein each component of the sentiment vector is assigned a number in a numerical range, the two extrema of the numerical range indicating most negative and most positive sentiments, respectively.

6. The computer-implemented method of claim 3, wherein determining a sentiment-targeting score for each respective identified ad is performed using a lookup table that operates on the sentiment vector, the lookup table indicating a relative degree of appropriateness of the respective identified ad with respect to the sentiment vector.

7. The computer-implemented method of claim 1, wherein ranking the plurality of identified ads is further based at least in part on a correlation between the one or more sentiments of the content of the online session and an ad creative of each respective identified ad.

8. A non-transitory computer-readable storage medium including instructions for providing targeted online advertisement, the instructions when executed causing at least one computer system to:
receive a request for an ad to be provided to a user in an online session;
identify, using a processor of a computer, a plurality of ads as candidates for consideration;
determine, using a processor of a computer, one or more sentiments of a content of the online session;
rank, using a processor of a computer, the plurality of identified ads based at least in part on (i) a correlation between the content of the online session and a content of each respective identified ad, and (ii) a correlation between the one or more sentiments of the content of the online session and the content of each respective identified ad;
select, using a processor of a computer, an ad among the plurality of identified ads based at least in part on a result of the ranking; and
provide the selected ad to be displayed to the user in response to the request.

9. The non-transitory computer-readable storage medium of claim 8, wherein ranking the plurality of identified ads comprises:
determining, using a processor of a computer, a sentiment score for each respective identified ad based at least in part on (i) a correlation between the content of the online session and a content of each respective identified ad, and (ii) a correlation between the one or more sentiments of the content of the online session and the content of each respective identified ad; and
ranking the plurality of identified ads according to the sentiment scores.

10. The non-transitory computer-readable storage medium of claim 9, wherein determining one or more sentiments of a content of the online session comprises determining a sentiment vector for the content of the online session, the sentiment vector having one or more components corresponding to the one or more sentiments.

11. The non-transitory computer-readable storage medium of claim 10, wherein each component of the sentiment vector is in one of three states: (i) positive, (ii) neutral, or (iii) negative.

12. The non-transitory computer-readable storage medium of claim 10, wherein each component of the sentiment vector is assigned a number in a numerical range, the two extrema of the numerical range indicating most negative and most positive sentiments, respectively.

13. The non-transitory computer-readable storage medium of claim 10, wherein determining a sentiment-targeting score for each respective identified ad is performed using a lookup table that operates on the sentiment vector, the lookup table indicating a relative degree of appropriateness of the respective identified ad with respect to the sentiment vector.

14. The non-transitory computer-readable storage medium of claim 8, wherein ranking the plurality of identified ads is further based at least in part on a correlation between the one or more sentiments of the content of the online session and an ad creative of each respective identified ad.

15. A system for providing targeted online advertisement, comprising:
a processor; and
at least one memory device storing instructions that, when executed by the processor, cause the system to:
receive a request for an ad to be provided to a user in an online session;
identify, using a processor of a computer, a plurality of ads as candidates for consideration;
determine, using a processor of a computer, one or more sentiments of a content of the online session;
rank, using a processor of a computer, the plurality of identified ads based at least in part on (i) a correlation between the content of the online session and a content of each respective identified ad, and (ii) a correlation between the one or more sentiments of the content of the online session and the content of each respective identified ad;
select, using a processor of a computer, an ad among the plurality of identified ads based at least in part on a result of the ranking; and
provide the selected ad to be displayed to the user in response to the request.

16. The system of claim 15, wherein ranking the plurality of identified ads comprises:
determining, using a processor of a computer, a sentiment score for each respective identified ad based at least in part on (i) a correlation between the content of the online session and a content of each respective identified ad, and (ii) a correlation between the one or more sentiments of the content of the online session and the content of each respective identified ad; and
ranking the plurality of identified ads according to the sentiment scores.

17. The system of claim 16, wherein determining one or more sentiments of a content of the online session comprises determining a sentiment vector for the content of the online session, the sentiment vector having one or more components corresponding to the one or more sentiments.

18. The system of claim 17, wherein each component of the sentiment vector is in one of three states: (i) positive, (ii) neutral, or (iii) negative.

19. The system of claim 17, determining a sentiment-targeting score for each respective identified ad is performed using a lookup table that operates on the sentiment vector, the lookup table indicating a relative degree of appropriateness of the respective identified ad with respect to the sentiment vector.

20. The system of claim 15, wherein ranking the plurality of identified ads is further based at least in part on a correlation between the one or more sentiments of the content of the online session and an ad creative of each respective identified ad.
